(19) United States
(12) Patent Application Publication
(10) Pub. No.: US 2017/0046765 A1
(43) Pub. Date: Feb. 16, 2017

(54) SYSTEM AND METHOD PROVIDING CROSS-BRANDED VIRTUALIZED INVENTORY CAPABILITY

(71) Applicant: Liquid Verticals, LLC, Austin, TX (US)

(72) Inventors: Erik Dreyer, Austin, TX (US); John C. Fleming, The Hills, TX (US); Gary Forni, Buda, TX (US)

(73) Assignee: LIQUID VERTICALS, LLC, Austin, TX (US)

(21) Appl. No.: 14/854,101

(22) Filed: Sep. 15, 2015

Related U.S. Application Data
(60) Provisional application No. 62/203,342, filed on Aug. 10, 2015.

(51) Int. Cl. G06Q 30/06; G06Q 20/40

(52) U.S. Cl. CPC G06Q 30/0625; G06Q 20/401

(57) ABSTRACT

Systems and methods in accordance with the disclosures made herein uniquely aggregates inventory into a virtual inventory for multiple dealers. The virtual inventory provides the ability to access a variety of private inventory pools simultaneously and have the ability to search these inventories including one's physical stock, thereby creating an added dimension of inventory for buyers and sellers and allowing more opportunities for faster transactions at normalized pricing. With greater supply and demand, there is greater probability of prices finding the optimum trading level. In this manner, the virtual inventory is a supplement to physical inventory. The virtual inventory allows dealers to be more judicious about the level of inventory investment they need to achieve a target service levels. Inventory aggregation can be in the form of private pools of cross-brand, virtualized inventory of a subset of a plurality of dealers.

### CROSS REFERENCE TO RELATED APPLICATIONS

This patent application claims priority from co-pending U.S. Provisional Patent Application having Ser. No. 62/203,342, filed 10 Aug. 2015, entitled “SYSTEM AND METHOD PROVIDING CROSS-BRANDED VIRTUALIZED INVENTORY CAPABILITY”, having a common applicant herewith and being incorporated herein in its entirety by reference.

### FIELD OF THE DISCLOSURE

The disclosures made herein relate generally to computer networks and, more particularly, to a computer network system and method providing cross-brand virtualized inventory capability.

### BACKGROUND

Original equipment (OE) dealers of products are typically focused on systems to sell new product rather than used product. Consequently, a high percentage of used product offered by OE dealers is sold through brokers or auction. Selling used products via auctions and brokers largely rewards the ‘middlemen’ of the brokerage or auction, as opposed to the selling or buying party. The middlemen increase market inefficiencies due to disparate pricing variances resulting in substantial regional price differentials, longer trading cycles and greater profit for the middlemen at the expense of the selling and buying parties.

Heavy equipment dealers, like other types of OE dealers, have many sophisticated tools and telematics to support and monitor new equipment inventory and in the field. However, there are virtually no tools for used (e.g., aftermarket) equipment sales except for basic inventory planning tools and manual marketing efforts. For example, it is estimated that up to 85% of heavy equipment machinery (dozers, tractors, excavators and the like) is sold through brokers or auction as opposed to directly through the OE dealer itself.

Like other many other categories of equipment manufacturers (OEMs), OEMs of heavy equipment are attempting to stimulate new product sales by incentivizing their OE dealers to buy new machines for inclusion in their rental fleets. Due to recent market realities and the challenge for heavy equipment end-users (contractors) to be able to buy new machines that have been escalating in price (e.g., due to Tier 4 environmental regulations such as the 1990 Clear Air Act that included off road Heavy Equipment), this strategy of incentivizing OE dealers to buy new machines for inclusion in their rental fleets has gained momentum. However, a problem for OE dealers that own heavy equipment rental fleets is how to dispose of the growing volume of rental units (i.e., a portion of their surplus inventory). To date, they have relied more and more on auctions and wholesale brokers that each bring only a select number of buyers and sellers, thereby taking the price control away from the selling OE dealer.

Still another problem for OE dealers relates to off-brand inventory. Currently, if a dealer of a first brand (e.g., brand A) takes in piece of equipment of a second brand (e.g., brand B), such as via a trade-in, this ‘on-brand’ dealer has significant challenge associated with having this piece of ‘off-brand’ equipment in its inventory. Examples of such challenges include, but are not limited to, on-brand dealers generally do not have the qualifications or ability to service off-brand units, off-brand units sold in territory of an on-brand dealer takes away from its new sales opportunities, buyers of off-brand units are most often the corresponding on-brand dealer of the off-brand units, and there is no common trade platform or marketing channel for this off-brand equipment transaction to take place other than a manual search and inquiry on a per-machine basis.

In this respect, as is well known in OE dealer markets (e.g., heavy equipment or otherwise), dealers currently are not afforded with beneficial alternatives to auction and brokers for the sale of used on-brand equipment and off-brand equipment. Because of this, a significant opportunity exists to address these adverse issues and ultimately add to the dealer's revenue by reducing inventory costs and increasing operational efficiencies. Therefore, a solution that overcomes drawbacks and limitations associated with these on-brand inventory and off-brand inventory considerations would be advantageous, desirable and useful.

### SUMMARY OF THE DISCLOSURE

Embodiments of the present invention are directed to systems and methods for advantageously implementing sale of on-brand inventory and off-brand inventory. More specifically, embodiments of the present invention provide for a virtual inventory compiled from at least a portion of inventory (e.g., products thereof) of a plurality of disparate dealers. Dealers are an example of a user of embodiments of the present invention. In some embodiments, two or more of the disparate dealers are dealers that offer a different respective brand of product (e.g., heavy equipment), thereby providing a cross-brand virtual inventory. Advantageously, a cross-brand virtual inventory enables users and buyers to access multiple brand sources/inventories simultaneously to buy and sell equipment.

A system configured in accordance with an embodiment of the present invention can include an Active Inventory Manager (AIM) that uniquely aggregates inventory into a virtual inventory for multiple dealers. The virtual inventory provides the ability to access a variety of private inventory pools simultaneously and have the ability to search these inventories including one's physical stock, thereby creating an added dimension of inventory for buyers and sellers. This allows more opportunities for faster transactions at normalized pricing. With greater supply and demand, there is greater probability of prices finding the optimum trading level. In this manner, the virtual inventory is a supplement to physical inventory (e.g., “inventory in the cloud”). The virtual inventory allows dealers to be more judicious about the level of inventory investment they need to achieve a target service levels. Inventory aggregation can be in the form of private pools of inventory that are managed by individualized and confidential dealer codes (e.g., a cross-brand virtualized inventory of a subset of a plurality of dealers).

With a virtual supply available via AIM, dealers can advantageously reduce physical inventory while maintaining a suitable stock of inventory items supplied via the virtual inventory. The virtual inventory can also be used to supplement lead-time and buffer emergency stock out situations for managing lost sales prevention. When managing a rental fleet, for example, one can reduce the fleet and increase the utilization rate by using AIM and the virtual inventory as the backup and alternative to costly physical inventory (i.e., rental fleet utilization).

Virtual inventory in accordance with embodiments of the present invention adds value to buyers and sellers alike as dealers utilizing the AIM (i.e., AIM members) constitute a virtual market (VM) within the AIM. Each VM can be segmented by preferences of an AIM member as defined in the member's profile. Products or brands of interest are recorded at setup and alerts/notifications are generated base this input. Thus, AIM members are readily and continually able to see market dynamics in the VM segments for their defined area of interest and act or engage as they choose.

In preferred embodiments of the present invention, the AIM is implemented as a cloud based process that automates the action(s) of a business broker or a multitude of business brokers to bring a buyer and seller to a point of negotiation. In view of the disclosures made herein, a skilled person will appreciate that the AIM facilitates functionalities such as, for example, aggregating buyers and sellers in lieu of needing a middleman, creation and management of a virtual inventory, increased transaction velocity, and normalization of prices toward a market equilibrium.

In preferred embodiments of the present invention, escrow capability is provided across all brands and all transactions to ensure transactional integrity. Advantageously, by linking sales transactions via a common escrow process for high-speed, high dollar asset trades adds a trade facilitation element of security. This escrow process replaces the need for letters of credit and related payment process in many international transactions.

In one embodiment, a system comprises a plurality of dealer inventory management apparatuses and a virtual inventory management server. The dealer inventory management apparatuses are each associated with a respective one of a plurality of inventory item dealers. Each one of the inventory item dealers is a dealer for a respective brand of inventory item. The virtual inventory management server is accessible by each one of the dealer inventory management apparatuses The virtual inventory management server enables a cross-brand virtual inventory of each one of the inventory item dealers to be created and searched. The cross-brand virtual inventory of a particular one of the inventory item dealers includes inventory of at least one other one of the inventory item dealers.

In another embodiment, a method is implemented via execution of instructions by one or more data processing devices in response to being accessed from memory by the one or more data processing devices. The method comprises receiving, from each one of a plurality of inventory item dealers, inventory item information for at least one inventory item thereof; maintaining information enabling a virtual inventory for each one of the inventory item dealers to be determined; and in response to receiving a search request from a particular one of the inventory item dealers, searching the virtual inventory of the particular one of the inventory item dealers for an inventory item specified in the search request. The virtual inventory of the particular one of the inventory item dealers includes the at least one inventory item of at least one other one of the inventory item dealers.

In another embodiment, a server comprises a data structure and a virtual inventory management engine coupled to the data structure. The data structure includes inventory item information for at least one inventory item of each one of a plurality of inventory item dealers and virtual inventory specifying information for each one of the inventory item dealers. The virtual inventory specifying information for each one of the inventory item dealers defines one or more other inventory item dealers whose inventory is included in a virtual inventory thereof. The a virtual inventory management engine is configured for searching the virtual inventory of a particular one of the inventory item dealers for an inventory item specified in a search request received therefrom.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a diagrammatic view of a system configured in accordance with an embodiment of the present invention for providing virtual inventory management functionality via a plurality of interconnected data computing apparatuses.

FIG. 2 is a block diagram view showing dealer inventory management functionality configured in accordance with an embodiment of the present invention.

FIG. 3A is a diagrammatic view showing an import tool configured in accordance with an embodiment of the present invention.

FIGS. 3B and 3C are diagrammatic views each showing respective aspects of a search tool configured in accordance with an embodiment of the present invention.

FIG. 4 is a block diagram view showing cross-brand virtual inventory search functionality configured in accordance with an embodiment of the present invention.

FIG. 5 is a diagrammatic view showing the search tool of FIGS. 3B and 3C indicating the results of a search within virtual inventory configured in accordance with an embodiment of the present invention.

FIG. 6 is a block diagram view showing virtual inventory sales order management functionality configured in accordance with an embodiment of the present invention.

FIG. 7 is a diagrammatic view of a first embodiment of a data processing apparatus to use for implementing virtual inventory management functionality configured in accordance with an embodiment of the present invention.

FIG. 8 is a diagrammatic view of a second embodiment of a data processing apparatus to use for implementing virtual inventory management functionality configured in accordance with an embodiment of the present invention.

### DETAILED DESCRIPTION

Preferred embodiments of the present invention provide for virtual inventory and cross brand transactional capabilities. For example, a computer network configured in accordance with an embodiment of the present invention advantageously provides for simultaneous yet independent access to a cross-brand virtual inventory (e.g., new and/or used product inventory) by each one of a plurality of disparate dealers (i.e., users). Additionally, preferred embodiments of the present invention provide unified escrow functionality for sales transactions involving any brand of product in the virtual inventory thereby ensuring transactional integrity.

Advantageously, a virtual inventory implemented in accordance with embodiments of the present invention provides for access to a variety of private inventory pools of a set of disparate dealers that have been compiled (e.g., aggregated) into a single inventory. Dealers are able to access the virtual inventory, including one's physical inventory, for the purpose of searching inventory items and initiating sales transactions for one or more of the inventory items. In this manner, the virtual inventory provides for more opportunities for faster transactions at a pricing that is set by market supply and demand (i.e., normalized pricing). Furthermore, with greater supply and demand, there is a greater probability of prices of inventory items in the virtual inventory finding their optimum trading level.

In preferred embodiments, because two or more of the dealers participating in the virtual inventory are each an OE dealer for one or more respective brands of product, the virtual inventory is a cross-brand virtual inventory. Cross-brand refers to a singular inventory of physical product of dealers offering different brands of OE product and the associated ability to access multiple brand sources/inventories simultaneously to buy and sell product. With respect to new equipment, a first dealer is that of a first brand (e.g., brand A) and a second dealer is that of a second brand (e.g., brand B), thereby contributing to the cross-brand nature of the virtual inventory (i.e., brand A product of the first dealer and brand B product of the second dealer). With respect to used product, a dealer of a first brand (e.g., brand A) takes in piece of equipment of a second brand (e.g., brand B), such as via a trade-in, thereby contributing to the cross-brand nature of the virtual inventory (i.e., brand B product of the first dealer that is an OE dealer for brand A product).

An advantageous aspect of embodiments of the present invention is providing dealers with an effective and efficient means of liquidating product of a brand that it is not a dealer (i.e., ‘off-brand’ product). It is well-known that when a dealer of a particular brand of product acquires ‘off-brand’ product, such as via a trade-in, that dealer often has significant challenges associated with selling that ‘off-brand’ product from within with its physical inventory. Embodiments of the present invention largely overcome such challenges by allowing the off-brand product of one dealer to now become virtual inventory of an OE dealer for the brand of the off-brand product. More specifically, via a virtual inventory in accordance with embodiments of the present invention, the off-brand product becomes available on-brand product inventory for one or more other dealers participating in the virtual inventory (i.e. one or more OE dealers of the brand of the off-brand product).

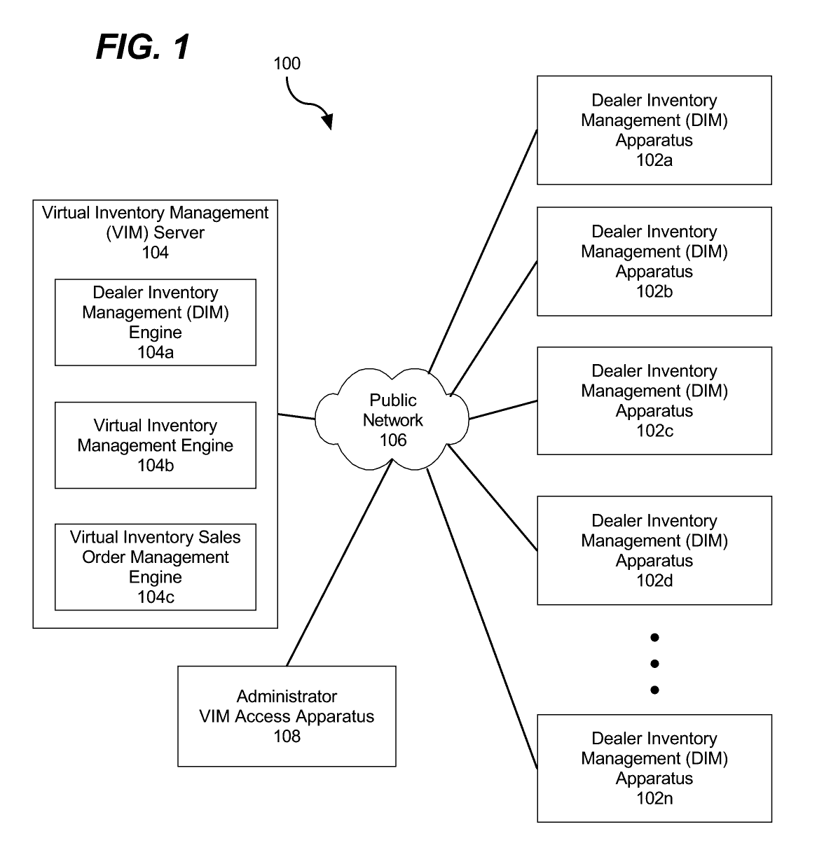

Referring now to FIG. 1, a system 100 configured in accordance with an embodiment of the present invention is shown (i.e., a cross-brand virtual inventory system). The system 100 includes a plurality of dealer inventory management (DIM) apparatuses 102a-102n (e.g., data computing apparatuses) are coupled to a virtual inventory management (VIM) server 104 (i.e., a data computing apparatus) through a public network 106 (e.g., the Internet). An administrator VIM access apparatus 108 is connected to the VIM server 104 through the public network 106. The VIM server 104 is specifically configured for implementing various VIM functionality such as, for example, managing information defining a respective product inventory of each one of the DIM apparatuses 102a-102n (i.e., a plurality of dealer inventories); managing creation, searching, and updating of one or more virtual inventories comprising inventory items selected from two or more of the dealer inventories; and managing sales orders for product selected from within a virtual inventory. It is disclosed herein that different subsets of the DIM apparatuses 102a-102n can have different respective virtual inventory associated therewith, as defined by the VIM server 104. The administrator VIM access apparatus 108 is specifically configured for enabling access and control of VIM functionality performed by the VIM server 104.

In view of the disclosures made herein, a skilled person will appreciate that network VIM functionality can be cloud based for members only such as, for example, in a business-to-business (B2B) structure in which members are invited to join and are then each password protected. It is also disclosed herein that embodiments of the present invention can be configured for business-to-consumer (B2C) membership and/or a consumer-to-consumer (C2C) membership. In this respect, although communication between the DIM apparatuses 102a-102n and the VIM server 104 can be implemented via a public network in preferred embodiments, access to the VIM server 104 by the DIM apparatuses 102a-102n can have a password-protected login. Furthermore, a skilled person will also understand that communication between the DIM apparatuses 102a-102n and the VIM server 104 can be implemented via a private network (e.g., standalone private network or private network (e.g., virtual private network) within a public network). A public network and a private network are disclosed herein as being examples of a communication network.

The VIM server 104 is specifically configured for using dealer inventory information provided by two or more of the DIM apparatuses 102a-102n to create one or more virtual inventories that each comprise at least a portion of the product inventory of such two or more DIM apparatuses 102a-102n. To this end, each one of the DIM apparatuses 102a-102n can access the VIM server 104 for providing respective inventory information to the VIM server 104. Examples of inventory information for a respective DIM apparatuses 102a-102n includes, but is not limited to, dealer identification information, inventory item identification information, inventory item characterizing information, and the like. The VIM server 104 utilizes such respective inventory information of the DIM apparatuses 102a-102n to create and maintain a respective dealer inventory defined by the product inventory information of each one of the DIM apparatuses 102a-102n, and from which the one or more virtual inventories is created.

The VIM server 104 can be configured to include a plurality of engines, as illustrated in FIG. 1. Examples of the engines include, but are not limited to, a dealer inventory management (DIM) engine 104a that is configured to manage information defining a respective dealer inventory of each one of the DIM apparatuses 102a-102n; a virtual inventory management engine 104b that is configured to create, enable searching of, and update of one or more virtual inventories (e.g., one or more cross-brand virtual inventory) comprising inventory items selected from dealer inventories; and a virtual inventory sales order management engine 104c that is configured to manage sales orders for product selected from within a virtual inventory.

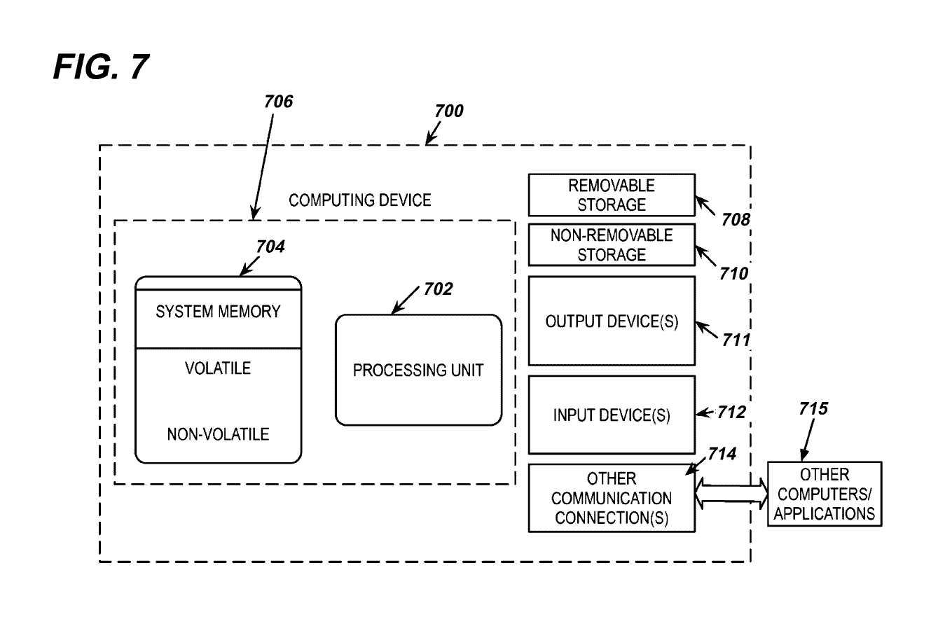

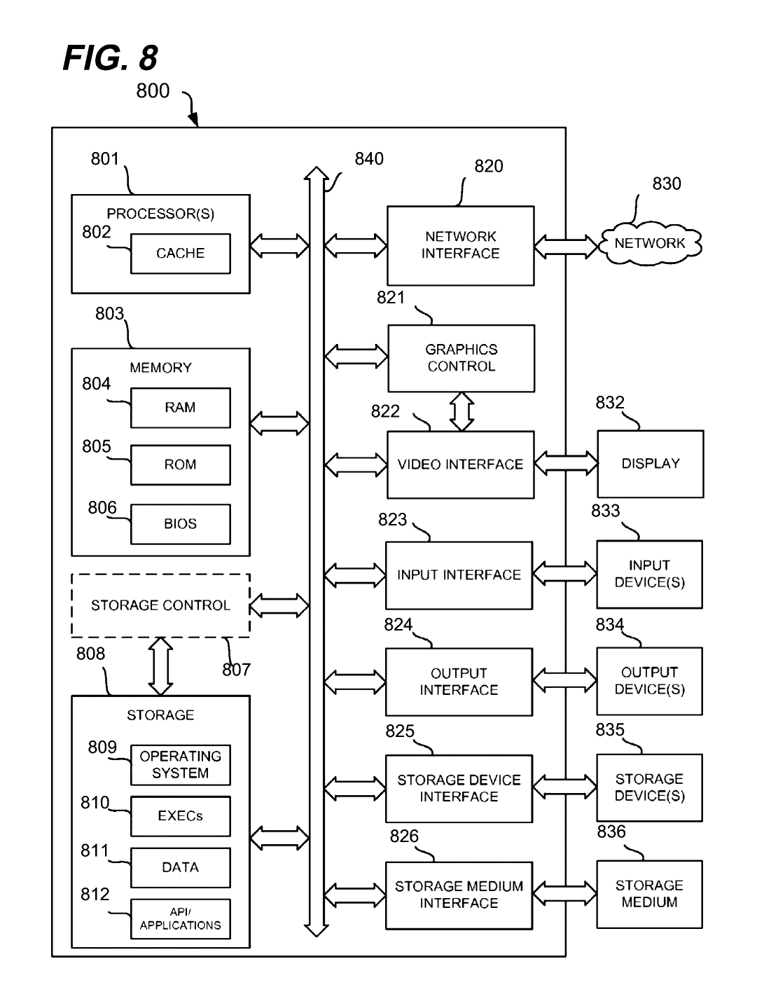

Each one of the engines can be embodied as a combination of computing resources and respective instructions accessed by and carried out by one or more respective portions of such computing resources. For example, a particular engine can include respective instructions that are accessible from a non-transitory computer-readable medium and that are executed by one or more data processing processor for implementing a respective functionality defined by the instructions. Further details of such computing resources and ability to carry out functionality as defined by instructions are discussed herein in reference to FIGS. 7 and 8.

In preferred embodiments, each one of the DIM apparatuses 102a-102n provides a respective OE dealer with virtual inventory management functionality as disclosed herein. To this end, each one of the DIM apparatuses 102a-102n advantageously provides for simultaneous yet independent access to a cross-brand virtual inventory (e.g., new and/or used product inventory) by each one of a plurality of disparate dealers (i.e., users). Each one of the dealers can have access to a common virtual inventory and/or a separate virtual inventory (e.g., having a subset of the product in the common virtual inventory). Advantageously, such virtual inventory management functionality provides for access to a variety of private inventory pools of a set of disparate dealers that have been compiled (e.g., aggregated) into a single inventory. Dealers are able to access the virtual inventory, including one's physical inventory, for the purpose of searching inventory items and initiating sales transactions for one or more of the inventory items.

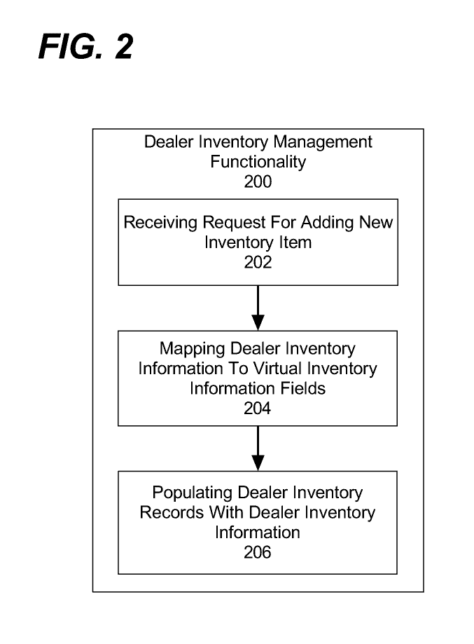

FIG. 2 shows dealer inventory management functionality 200 performed in accordance with by an embodiment of the present invention for managing dealer inventory. To this end, the dealer inventory management functionality 200 serves to manage information defining a respective dealer inventory of each one of a plurality of dealer inventory management apparatuses. In preferred embodiments, the inventory management functionality 200 is performed by the dealer inventory management engine 104a of the virtual inventory server 104.

The dealer inventory management functionality 200 includes an operation 202 for receiving a request for adding a new inventory item to inventory records of a particular dealer. For example, the request for adding the new inventory item can correspond to a command issued from a respective one of the DIM apparatuses 102a-102n. The request for adding the new inventory item designates a location of or includes the source of dealer inventory information for the new inventory item. In response to receiving the request for adding the new inventory item, an operation 204 is performed for mapping dealer inventory information fields designated by the particular dealer (i.e., the respective one of the DIM apparatuses 102a-102n) to virtual inventory information fields maintained on the virtual inventory server 104. It is disclosed herein that mapping of the dealer inventory information fields to the virtual inventory information fields need only be performed once for a giving format of dealer inventory information such as for a given inventory information format of a native inventory management system of a respective one of the DIM apparatuses 102a-102n (e.g., a native data structure or designated export data structure thereof). After mapping of the dealer inventory information fields is completed, an operation 206 is performed for populating a dealer inventory record maintained on the virtual inventory server 104 with inventory item parameters that define the inventory item to be added. The inventory item parameters include a dealer identifier such that dealer inventory records of each one of a plurality of dealers can be associated therewith.

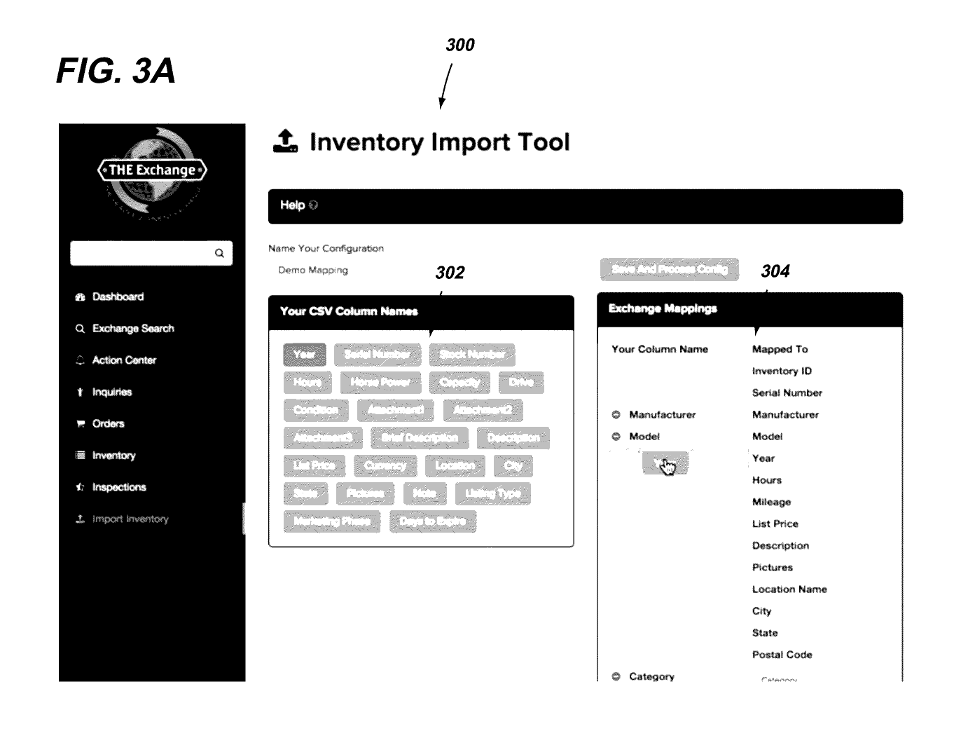

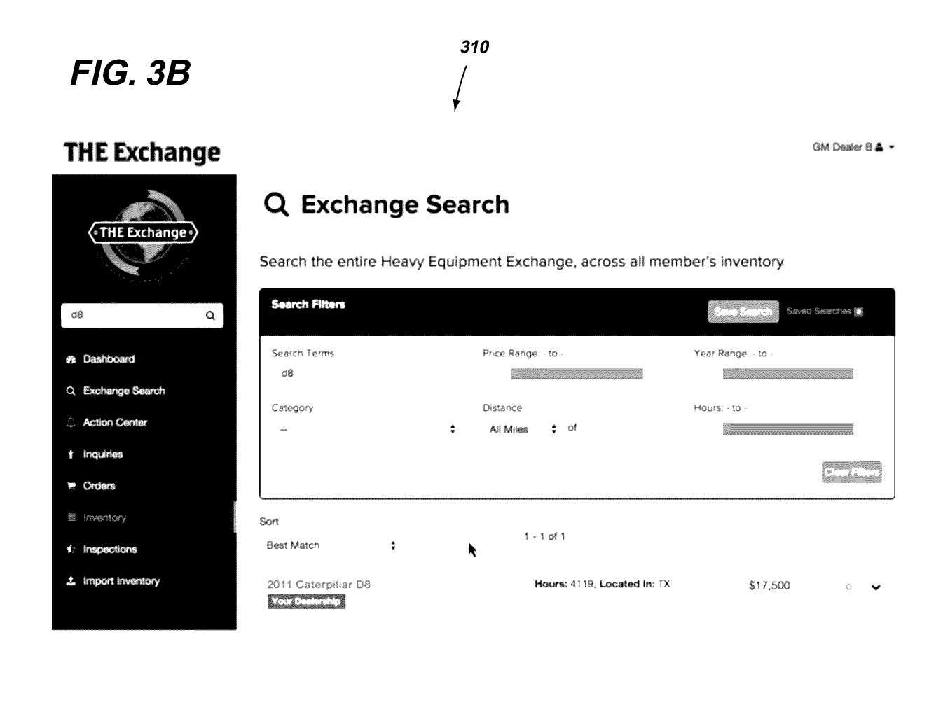

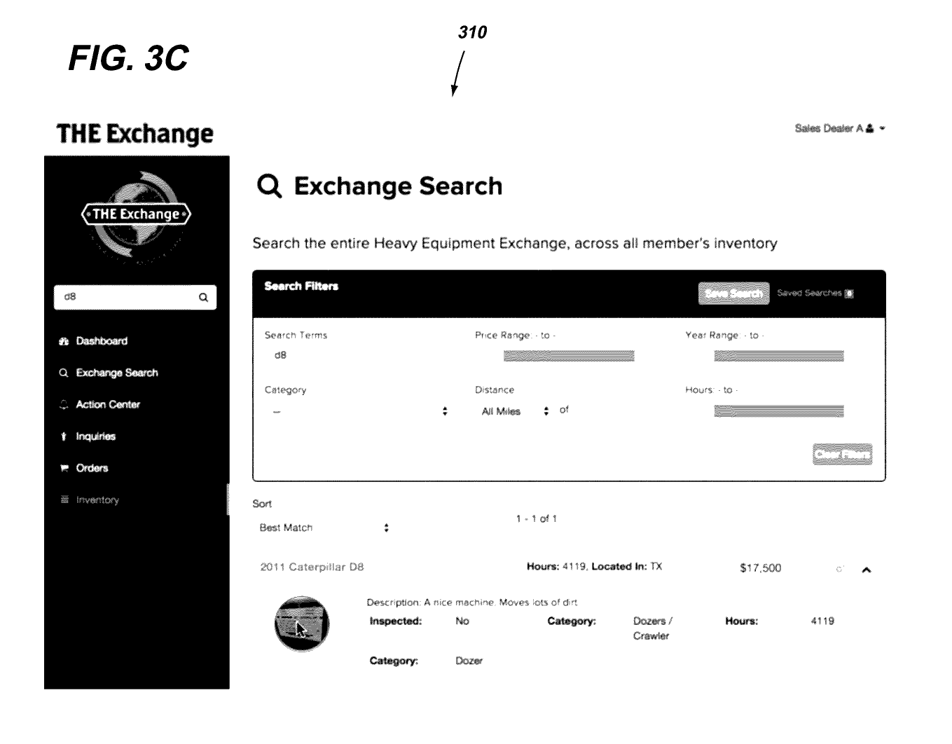

As shown in FIG. 3A, an import tool 300 configured in accordance with an embodiment of the present invention can be used for importing the dealer inventory information into a dealer inventory record maintained on the virtual inventory server 104 (e.g., as part of the dealer inventory management engine 104a). To this end, the dealer inventory information includes a plurality of inventory item parameters that define the inventory item to be added. Each one of the inventory item parameters corresponds to a respective parameter name 302 within a native inventory management system of the respective one of the DIM apparatuses 102a-102n (i.e., the inventory system used by the dealer to which the respective one of the DIM apparatuses 102a-102n is associated). For example, inventory item parameters and parameter names for one or more inventory items can be recorded in or outputting into a columnar, tabular, or other similarly formatted data structure (e.g., in a spreadsheet). In this manner, dealers are able to make existing inventory item information available searchable via CSV (comma separated values) upload or DMS (data management system) integration within a VIM system (e.g., server) configured in accordance with embodiments of the present invention. In the case of a dealer inventory system that can produce a CSV file and automatically send that file to a known location, it is disclosed herein that the dealer can set this up to happen automatically according to a schedule for enabling a virtual inventory management system configured in accordance with an embodiment of the present invention to detect when a new file has been uploaded and to process it using the correct (e.g., previously mapped) CSV import configuration.

Mapping of the dealer inventory information for the new inventory item to virtual inventory information fields using the import tool 300 includes associating (e.g., via dragging and dropping) each one of a plurality of the parameter names 302 from the native management system with a corresponding one of a plurality of virtual inventory information fields 304 in dealer inventory records maintained on the virtual inventory server 104. In this manner, the inventory item parameters for each dealer inventory item become correlated to a corresponding one of the virtual inventory information fields 304 in a respective one of the dealer inventory records. Advantageously, such correlation enables dealer inventory information from different native inventory management system to be instantiated in a common format within dealer inventory records maintained on the virtual inventory server 104, regardless of differences in the format of the dealer inventory information in different native inventory management systems.

FIGS. 3B and 3C each show a search tool 310 configured in accordance with an embodiment of the present invention. As shown in FIGS. 3B and 3C, the newly added inventory item becomes searchable via the search tool 310 after the dealer inventory record maintained on the virtual inventory server 104 is populated with inventory item parameters that define the newly added inventory item (i.e., a D8 model Caterpillar brand dozer). FIG. 3B is a summary view of inventory items (only newly added item is shown) for a particular dealer (i.e., the dealer associated with newly added item). FIG. 3C is a detailed view of the inventory item parameters for the newly added item. In preferred embodiments, the search tool is implemented via an engine (e.g., the virtual inventory management engine 104b) configured for searching the virtual inventory of a particular one of a plurality of inventory item dealers for an inventory item specified in a search request received therefrom.

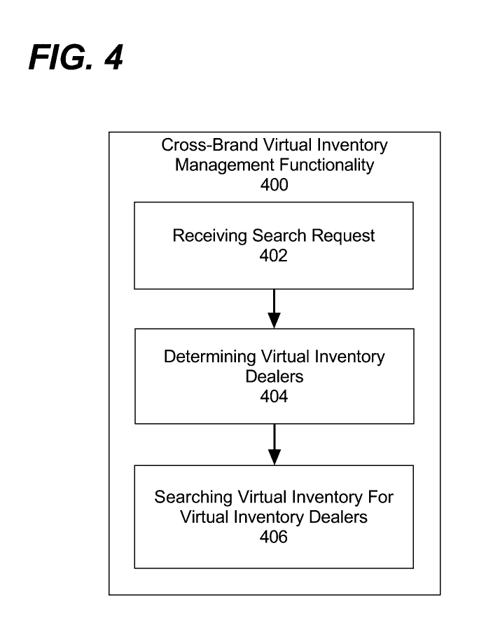

FIG. 4 shows cross-brand search functionality 400 performed in accordance with by an embodiment of the present invention to create, enable searching of, and update of one or more cross-brand virtual inventories comprising inventory items selected from dealer inventories. To this end, the cross-brand search functionality 400 serves to compile inventory from a plurality of dealers thereby allowing an off-brand inventory item of a particular dealer to become an inventory item of another dealer (i.e., an on-brand inventory item thereof). In this respect, as discussed above, because two or more of the dealers participating in the virtual inventory are each an OE dealer for one or more respective brands of product, the virtual inventory is a cross-brand virtual inventory. More specifically, a singular inventory of physical product of dealers offering different brands of OE product is the underlying basis for the cross-brand virtual inventory. Available inventory for a particular dealer is now extended via the virtual inventory to include that of one or more other dealers. Beneficially, off-brand inventory items for one or more of these other dealers may be on-brand inventory for the particular dealer (i.e., the inventory item is of a brand for which the particular dealer is an OE dealer). In preferred embodiments, the cross-brand search functionality 400 can be performed by the virtual inventory management engine 104b of the virtual inventory server 104.

The cross-brand search functionality 400 includes an operation 402 for receiving a search request from a particular dealer. For example, the search request can correspond to a command issued from a respective one of the DIM apparatuses 102a-102n. The search request specifies one or more search parameters. In preferred embodiments, at the time a dealer established an account (e.g., Brand A dealer) in a cross-brand virtual inventory system in accordance with the present invention, the dealer creates a “Saved Search” for their respective brand. For example, this can be as broad as “Search for Brand A” or as detailed as “Search for Brand A model 123 Year 2014 with less than 1500 hours” (i.e., search for a specific piece of heavy equipment). Furthermore, the dealer can predetermine other brands (e.g., in combination with specific item categories and specific item models) for which they want to be made aware of when they become available by another dealer having membership in the cross-brand virtual inventory system. This search capability establishes active automated search requests for the dealer's virtual inventory that will provide a notification whenever that search is matched with one or more corresponding inventory items, thereby allowing dealers (i.e., buyers) to immediate access an available inventory item. Advantageously, this search implementation facilitates sales activity for both buyers and sellers in real time, thereby providing timely (i.e., early) access to virtual inventory opportunities.

In response to receiving the search request, an operation 404 is performed for determining a plurality of dealer inventories to be jointly used as the virtual inventory for the search, followed by an operation 406 for searching the virtual inventory dependent upon the one or more search parameters defined in the search request. For example, the search request may be from a dealer (i.e., the DIM apparatus thereof) that is part of a group of dealers that is a subset of all dealers having the inventories served by the VIM 104, whereby only the dealer inventories of that subset of dealers comprises the virtual inventory that is searched. Where at least one of the two or more dealers has on-brand and off-brand inventory items within their dealer inventory of two or more dealers are OE dealers of different brands, the virtual inventory has the potential to be to a cross-brand virtual inventory.

In view of the disclosures made herein, a skilled person will appreciate that dealers can selectively adjust the sensitivity of their searches (e.g., saved searches) such that they are not flooded with unwanted search results. For example, a dealer is in a market that moves dozers (i.e., a particular heavy equipment item) and that dealer is particularly interested in a CAT D9 dozer (i.e., a specific model of such particular heavy equipment item). Although a CAT D9 dozer is a large and less demanded item, if it is that dealer's market, it can create a “Saved Search” to be notified of every CAT D9 dozer that becomes available in the dealer's virtual inventory (e.g., the system-wide virtual inventory or a subset thereof) or, alternatively, the dealer can create a saved search to be notified of any model and/or brand of dozer that becomes available in the dealer's virtual inventory. Such search options can be implemented via filters (e.g., brand filter, category filter, model filter, geographic area filter, etc) with such filters being used to fine-tune search results and notifications. Beneficially, off-brand inventory items will move more quickly with such a Save Search tool in that it allows a dealer to target what it wants to buy for its particular business (i.e., dealership).

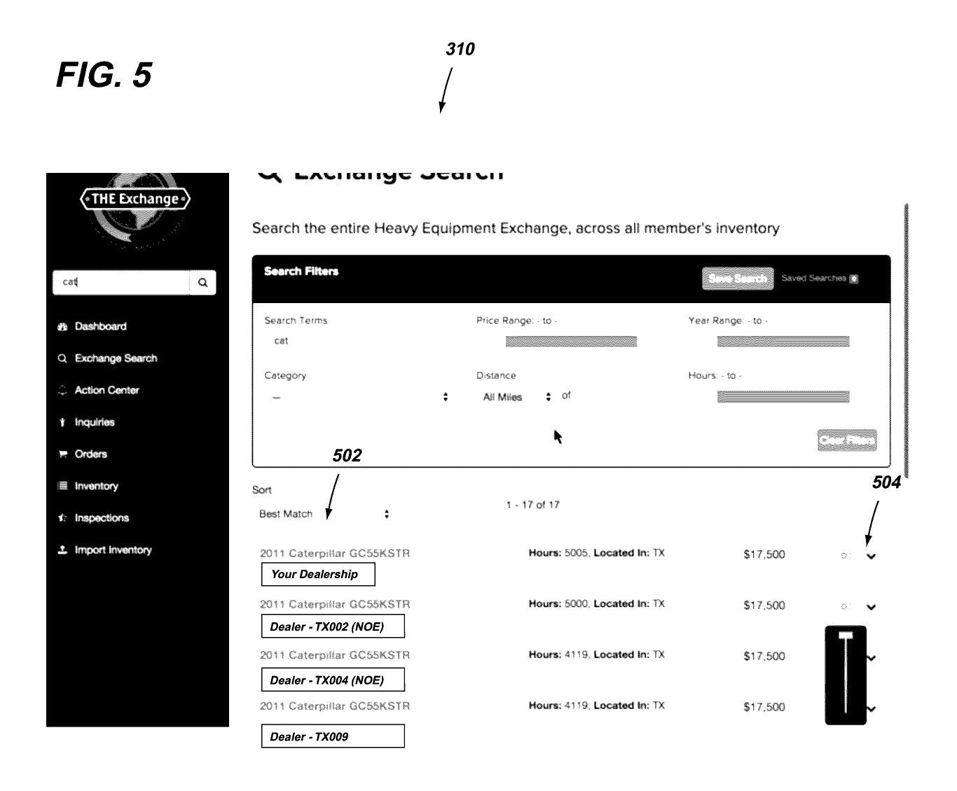

FIG. 5 shows the search tool 310, which was introduced above in reference to FIGS. 3B and 3C, indicating the results 502 of a search within the virtual inventory. As disclosed above, the virtual inventory can consist of inventory from all dealer inventories or a designated subset thereof. It is disclosed herein that virtual inventory specifying information of a particular inventory dealer can define the source of inventory included in the virtual inventory of the particular inventory dealer. Advantageously, the results 502 of the search of the virtual inventory include inventory items from a plurality of different dealers. The location and/or identity of the dealer can be denoted. Advantageously, such as for competitive bidding purposes, a notation that a particular dealer is not an OE dealer (i.e., non-OE dealer) for the associated item(s) revealed in the search. A full detail view for any item revealed in the search can be accessed (e.g., displayed) such as by selecting a ‘more info’ drop-down selector 504 for the item or performing another suitable action. The detailed information can include all or a portion of the information imported or otherwise entered by the dealer offering the inventory item.

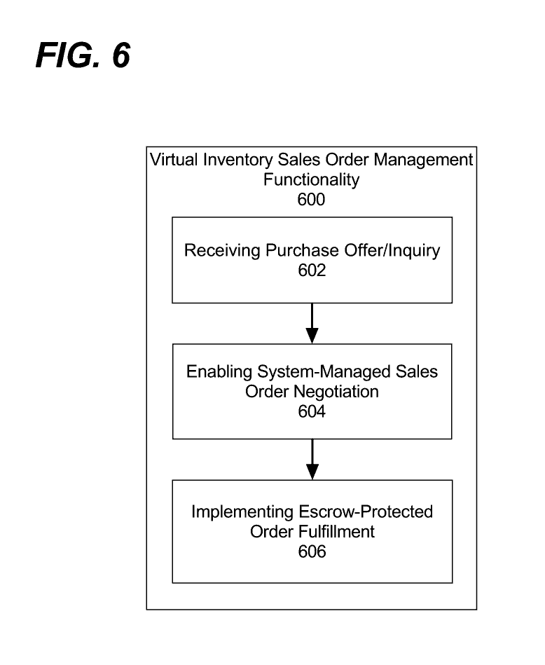

FIG. 6 shows virtual inventory sales order management functionality 600 performed in accordance with by an embodiment of the present invention for managing sales order processing of dealer inventory items. To this end, the dealer inventory management functionality 200 serves to allow for system-managed communication between buyers and sellers and to provide for a system-managed sales transaction. In preferred embodiments, the virtual inventory sales order management functionality 600 is performed by the virtual inventory sales order management engine 104c of the virtual inventory server 104.

The virtual inventory sales order management functionality 600 includes an operation 602 for receiving a purchase offer inquiry for an inventory item revealed in a search of a virtual inventory by a particular dealer. For example, the purchase offer inquiry can correspond to a command issued from a respective one of the DIM apparatuses 102a-102n. In response to receiving the purchase offer inquiry, an operation 604 is performed for implementing sales order negotiation that allows for terms of a sales agreement for the inventory item to be negotiated and agreed upon. In preferred embodiments, negotiation of such terms is advantageously performed in a system-managed manner (e.g., by the VIM server 104) such that interaction between buyer and seller for the purpose of arriving at an agreed upon sales order for the inventory item is implemented in accordance with system-defined rules. In response to a sales agreement being achieved and an agreed upon sales order being created, an operation 606 is performed for implementing escrow-protected sales order fulfillment for the inventory item being sold.

In preferred embodiments of the present invention, the escrow-protected sales order fulfillment is advantageously a mandatory element of the virtual inventory sales order management functionality 600 such that it is not possible, for example, for a buyer to pay cash and by-pass the escrow-protected sales order fulfillment process. In such embodiments, the mandatory escrow-protected sales order fulfillment provides a common medium for sales transactions in any accepted foreign exchange currency and insures that there is a mutual compliance on the part of both the buyer and the seller. Furthermore, such escrow-protected sales order fulfillment advantageously and uniquely engages both buyer and the seller in the final settlement. To this end, in preferred embodiments of the present invention, each dealer (i.e., users) agrees to set up a respective account in a common escrow processing entity.

Implementing escrow-protected sales order fulfillment is performed in a manner that links disbursement of payment for the inventory item from a system-integrated escrow fund with buyer-confirmed inspection of the inventory item. An agreed upon amount of funds (e.g., sales price from buyer and inspection fee from seller) is put into escrow at the time the sales order is confirmed (i.e., tendered offer from buyer is accepted by seller). The buyer and the seller both agree that the seller will certify that a third-party inspection report of the inventory item(s) of the sales order is correct and that the seller is responsible for any discrepancies from the inspection report. Furthermore, the buyer and the seller both agree that the buyer will have a minimum number of days to inspect and accept (e.g., X calendar days from date of receipt of the sales, Y work days, etc). In this manner, inspection terms are defined. Following inspection of the inventory item(s), the buyers receives the inventory item(s) and thereafter, per the inspection terms, has the agreed time to accept the inventory item(s). When the buyer finds the inventory item(s) to be in alignment with the inspection provided by the seller and confirms accepts the inventory item(s), the escrowed funds for the sales amount are transferred to the seller. As a safeguard for the seller and incentive for the buyer to promptly confirm or reject acceptance of the inventory item(s), if the buyer does not accept or reject the inventory item(s) within the time frame specified in the inspection terms, the escrowed funds for the sales amount are transferred to the seller.

Advantageously, implementing escrow-protected sales order fulfillment in accordance with embodiments of the present invention allows for completion of all sales order transactions for inventory items to be processed via escrow from any place in the world. The escrow process is automated such that, once escrow is funded, all other elements of the sales order fulfillment process are system-managed without human intervention, thereby assuring compliance by all parties involved in the sales order fulfillment. In this manner, embodiments of the present invention provide for secure trades (i.e., sales) and transfer of funds for inventory items (e.g., products) having attributes and properties that are highly variable and differentiated.

A skilled person will appreciate that an important consideration and significant difference between what is traded (i.e., sold) via a marketplace configured in accordance with an embodiment of the present invention and other marketplaces (e.g., a commodity exchange or stock exchange) is the variances in the product being traded. A share of stock is clearly defined, a bushel of wheat is clearly defined, gold is clearly defined, and diamonds are similarly defined by GIA certification based on defined properties. In contrast, products traded via a marketplace configured in accordance with an embodiment of the present invention have attributes and properties that are highly variable and differentiated. Embodiments of the present invention provide a single marketplace in which products having attributes and properties that are highly variable and differentiated can be efficiently and effectively traded.

As shown in FIG. 7, a first embodiment of a data processing apparatus 700 (i.e., a server) to use for implementing virtual inventory management functionality configured in accordance with an embodiment of the present invention. In preferred embodiments of the data processing apparatus 700, virtual inventory management functionality includes all or a portion of dealer inventory management functionality (e.g., as disclosed in reference to FIG. 2), cross-brand virtual inventory search functionality (e.g., as disclosed in reference to FIG. 4), and virtual inventory sales order management functionality (e.g., as disclosed in reference to FIG. 6). In its most basic configuration, data processing apparatus 700 typically includes at least one processing unit 702 and memory 704. Depending on the exact configuration and type of data processing apparatus, memory 704 may be volatile (such as RAM), non-volatile (such as ROM, flash memory, etc.) or some combination of the two. This most basic configuration is illustrated in FIG. 7 by dashed line 706. In view of the disclosures made herein, a skilled person will appreciate that data processing apparatus 700 can be configured for providing virtual inventory management functionality in accordance with an embodiment of the present invention (e.g., configured as the VIM server discussed above in reference to FIG. 1).

Additionally, data processing apparatus 700 may also have additional features/functionality. For example, device 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer readable instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 700. Any such computer storage media may be part of device 700.

Data processing apparatus 700 includes one or more communication connections 714 that allow data processing apparatus 700 to communicate with other computers/applications 715. Device 700 may also have input device(s) 712 such as keyboard, mouse, pen, voice input device, touch input device, etc. Output device(s) 711 such as a display, speakers, printer, etc. may also be included. These devices are well known in the art and need not be discussed at length here.

Systems and methods in accordance with embodiments of the inventive subject matter can be implemented in any number of different types of data processing apparatus (e.g., a server, a smart phone, and the like). To this end, FIG. 8 shows a diagrammatic representation of a second embodiment of a data processing apparatus 800 (e.g., an instance of one or more of user data processing apparatuses 1-n) within which a set of instructions can execute for causing a device to perform or execute any one or more of the aspects and/or methodologies of the present disclosure. In preferred embodiments of the data processing apparatus 800, virtual inventory management functionality includes all or a portion of dealer inventory management functionality (e.g., as disclosed in reference to FIG. 2), cross-brand virtual inventory search functionality (e.g., as disclosed in reference to FIG. 4), and virtual inventory sales order management functionality (e.g., as disclosed in reference to FIG. 6). The components in FIG. 8 are examples only and do not limit the scope of use or functionality of any hardware, software, embedded logic component, or a combination of two or more such components implementing particular embodiments.

The data processing apparatus 800 can include a processor 801 (e.g., one or more data processing devices), a memory 803, and storage 808 that communicate with each other, and with other components, via a bus 640. The bus 640 can also link a display 832, one or more input devices 833 (which can, for example, include a keypad, a keyboard, a mouse, a stylus, etc.), one or more output devices 834, one or more storage devices 835, and various tangible storage media 836. All of these elements can interface directly or via one or more interfaces or adaptors to the bus 640. For instance, the various tangible storage media 836 can interface with the bus 640 via storage medium interface 826. Data processing apparatus 800 can have any suitable physical form, including but not limited to one or more integrated circuits (ICs), printed circuit boards (PCBs), mobile handheld devices (such as mobile cellular telephones, tablets, or personal digital assistants (PDAs)), laptop or notebook computers, distributed computer systems, computing grids, or servers. All or a portion of the elements 801-836 can be housed in a single unit (e.g., a smart phone housing, a tablet housing, or the like).

Processor(s) 801 (or central processing unit(s) (CPU(s))) optionally contains a cache memory unit 802 for temporary local storage of instructions, data, or computer addresses. Processor(s) 801 are configured to assist in execution of computer readable instructions (i.e., a set of instructions). Data processing apparatus 800 can provide functionality as a result of the processor(s) 801 executing software embodied in one or more tangible computer-readable storage media, such as memory 803, storage 808, storage devices 835, and/or storage medium 836. The computer-readable media can store software that implements particular embodiments of the inventive subject matter, and processor(s) 801 can execute the software. Memory 803 can read the software from one or more other computer-readable media (such as mass storage device(s) 835, 836) or from one or more other sources through a suitable interface, such as network interface 820. The software can cause processor(s) 801 to carry out one or more processes or one or more steps of one or more processes described or illustrated herein. Carrying out such processes or steps can include defining data structures stored in memory 803 and modifying the data structures as directed by the software.

The memory 803 can include various components (e.g., machine readable media) including, but not limited to, a random access memory component (e.g., RAM 804) (e.g., a static RAM “SRAM”, a dynamic RAM “DRAM, etc.), a read-only component (e.g., ROM 805), and any combinations thereof. ROM 805 can act to communicate data and instructions unidirectionally to processor(s) 801, and RAM 804 can act to communicate data and instructions bidirectionally with processor(s) 801. ROM 805 and RAM 804 can include any suitable tangible computer-readable media described below. In one example, a basic input/output system 806 (BIOS), including basic routines that help to transfer information between elements within data processing apparatus 800, such as during start-up, can be stored in the memory 803.

Fixed storage 808 is connected bidirectionally to processor(s) 801, optionally through storage control unit 807. Fixed storage 808 provides additional data storage capacity and can also include any suitable tangible computer-readable media described herein. Storage 808 can be used to store operating system 809, EXECs 810 (executables), data 811, APV applications 812 (application programs), and the like. Often, although not always, storage 808 is a secondary storage medium (such as a hard disk) that is slower than primary storage (e.g., memory 803). Storage 808 can also include an optical disk drive, a solid-state memory device (e.g., flash-based systems), or a combination of any of the above. Information in storage 808 can, in appropriate cases, be incorporated as virtual memory in memory 803.

In one example, storage device(s) 835 can be removably interfaced with data processing apparatus 800 (e.g., via an external port connector (not shown)) via a storage device interface 825. Particularly, storage device(s) 835 and an associated machine-readable medium can provide nonvolatile and/or volatile storage of machine-readable instructions, data structures, program modules, and/or other data for the data processing apparatus 800. In one example, software can reside, completely or partially, within a machine-readable medium on storage device(s) 835. In another example, software can reside, completely or partially, within processor(s) 801.

Bus 640 connects a wide variety of subsystems. Herein, reference to a bus can encompass one or more digital signal lines serving a common function, where appropriate. Bus 640 can be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Preferably, the data processing apparatus 800 is configured to determine a location at which it is currently positioned. To this end, the data processing apparatus 800 can include a set of instructions for determining such location. A Global Positioning System (GPS) application accessible from within storage and/or memory of the data processing apparatus 800 (e.g., as an application accessible from within the storage 708) is an example of such a set of instructions for determining such location. In some embodiments, the set of instructions for determining such location cause at least a portion of information necessary for determining such location to be obtained from an external apparatus or system (e.g., via a network connection). Preferably, the location can be provided in the form of coordinates and/or a civic address.

Data processing apparatus 800 can also include an input device 833. In one example, a user of data processing apparatus 800 can enter commands and/or other information into data processing apparatus 800 via input device(s) 833. Examples of an input device(s) 833 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 833 can be interfaced to bus 640 via any of a variety of input interfaces 823 (e.g., input interface 823) including, but not limited to, serial, parallel, game port, USB, FIREWIRE, THUNDERBOLT, or any combination of the above.

In particular embodiments, when data processing apparatus 800 is connected to network 830, data processing apparatus 800 can communicate with other devices, specifically mobile devices and enterprise systems, connected to network 830. Communications to and from data processing apparatus 800 can be sent through network interface 820. For example, network interface 820 can receive incoming communications (such as requests or responses from other devices) in the form of one or more packets (such as Internet Protocol (IP) packets) from network 830, and data processing apparatus 800 can store the incoming communications in memory 803 for processing. Data processing apparatus 800 can similarly store outgoing communications (such as requests or responses to other devices) in the form of one or more packets in memory 803 and communicated to network 830 from network interface 820. Processor(s) 801 can access these communication packets stored in memory 803 for processing.

Examples of the network interface 820 include, but are not limited to, a network interface card, a modem, and any combination thereof. Examples of a network 830 or network segment 830 include, but are not limited to, a wide area network (WAN) (e.g., the Internet, an enterprise network), a local area network (LAN) (e.g., a network associated with an office, a building, a campus or other relatively small geographic space), a telephone network, a direct connection between two data processing apparatuses, and any combinations thereof. A network, such as network 830, can employ a wired and/or a wireless mode of communication. In general, any network topology can be used.

Information and data can be displayed through a display 832. Examples of a display 832 include, but are not limited to, a liquid crystal display (LCD), an organic liquid crystal display (OLED), a cathode ray tube (CRT), a plasma display, and any combinations thereof. The display 832 can interface to the processor(s) 801, memory 803, and fixed storage 808, as well as other devices, such as input device(s) 833, via the bus 640. The display 832 is linked to the bus 640 via a video interface 822, and transport of data between the display 832 and the bus 640 can be controlled via the graphics control 821.

In addition to a display 832, data processing apparatus 800 can include one or more other peripheral output devices 834 including, but not limited to, an audio speaker, a printer, and any combinations thereof. Such peripheral output devices can be connected to the bus 640 via an output interface 824. Examples of an output interface 824 include, but are not limited to, a serial port, a parallel connection, a USB port, a FIREWIRE port, a THUNDERBOLT port, and any combinations thereof.

In addition or as an alternative, data processing apparatus 800 can provide functionality as a result of logic hardwired or otherwise embodied in a circuit, which can operate in place of or together with software to execute one or more processes or one or more steps of one or more processes described or illustrated herein. Reference to software in this disclosure can encompass logic, and reference to logic can encompass software. Moreover, reference to a computer-readable medium (also sometimes referred to as machine-readable medium” can encompass a circuit (such as an IC) storing software for execution, a circuit embodying logic for execution, or both, where appropriate. The present disclosure encompasses any suitable combination of hardware, software, or both.

The term “computer-readable medium” should be understood to include any structure that participates in providing data that can be read by an element of a computer system. Such a medium can take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

Those of skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the inventive subject matter.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of data processing apparatuses, e.g., a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, Hard disk, a removable disk, a CD-ROM, or any other form of storage medium known in the art. An exemplary storage medium is coupled to the processor such the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

The previous description of the disclosed embodiments is provided to enable any person skilled in the art to make or use the inventive subject matter. Various modifications to these embodiments will be readily apparent to those skilled in the art, and the generic principles defined herein can be applied to other embodiments without departing from the spirit or scope of the inventive subject matter. Thus, the inventive subject matter is not intended to be limited to the embodiments shown herein but is to be accorded the widest scope consistent with the principles and novel features disclosed herein.

Presented now are details of a use case example for utilization of virtual inventory management functionality. Specifically, a heavy equipment exchange (referred to herein as “The Heavy Equipment Exchange”) is an example of an application for virtual inventory management functionality configured in accordance with embodiments of the present invention. Embodiments of the present invention are desirable to heavy equipment sales companies looking to benefit from the functionality and cost savings. Virtual inventory management (VIM), which is also referred to as Active Inventory Management or AIM, allows dealers of different brands to trade in a private wholesale market place and improve incremental income by faster more efficient transactions. One aspect of such transactions includes aged or surplus inventory that can be automatically marketed based on desired parameters to aggregated defined buyers with specific areas of interest. Thus, eliminating the need for manual manipulation. One aspect of such transactions includes moving competitive product taken in on trade to the respective dealers out of the sellers territory with the notification of ready to sell and ready to buy done electronically and automatically to facilitate more trades process faster. One aspect of such transactions includes consolidating inventory maintained in privately identified dealer centric pools can be selectively searched to meet a buyer's request. The method of aggregating inventory's of multiple locations and multiple brands creates a unique electronic marketplace of inventory that allows any given dealer the opportunity to reduce the months of inventory on hand and have lower carrying cost and faster turnover rates. One aspect of such transactions includes sales via a virtual inventory of multiple dealers/brands to help dealers reduce sales lost by the lack of physical availability. As all dealers utilize a common virtual inventory the advantages of dealer shopping for a retail buyer are reduced if not eliminated. Another aspect of such transactions includes optimization of product coming off lease or on rent or in stock all save cost, increase inventory turnover and increase incremental revenue. Another aspect of such transactions includes optimizing market places both horizontally and vertical in all possible markets where the dealer/broker or agent model drives wholesale transactions.

With respect to embodiments of the present invention providing for virtual inventory, the more inventory dealers/members make available for search the greater the pool of inventory available to all dealers. For example, If a dealer has 2200 units in its inventory (rental fleet 2000 and other 200) and its rental utilization rate is 60% (average today), then it would be carrying 800+200 or 1000 units. Thus, between 1000 units and the entire inventory of 2200 units can be available for search. If there are 10 other dealers with the substantially the same inventory profile, there would approximately 10,000 to 22,000 units available for search. In this respect, a dealer utilizing the virtual inventory has increased its available inventory by 10×. This dealer can then make an effort to reduce its inventory and rely more on the 10×. By reducing its rental fleet say from 2000 to 1500 units, it will increase its utilization rate from about 60% to about 80% (i.e., 1200/2000 vs. 1200/1500). When it needs a particular machine, it can use the virtual inventory to locate and add to its rental pool or sell to a user or add to its inventory for a known project coming on stream. In this respect, utilization of a virtual inventory in accordance with embodiments of the present invention gives the dealer added flexibility for less cost.

A primary goal of implementing virtual inventory management in accordance with embodiments of the present invention in The Heavy Equipment Exchange is to increase the speed (e.g., 5 days or less) and reduce the cost (e.g., from 20% to 3%). Thus, implementing virtual inventory management in accordance with embodiments of the present invention in The Heavy Equipment Exchange provides numerous financial benefits to the buyers, sellers and end users who trade in such heavy equipment (i.e., machines). Currently, the global wholesale market for such heavy equipment operates the same as in the US, which is dealer selling to auction company or broker who sell to dealers. Advantageously, The Heavy Equipment Exchange automates the steps between the dealers for more and faster transactions at lower cost.

Implementing virtual inventory management in accordance with embodiments of the present invention in The Heavy Equipment Exchange advantageously impacts the manner in which dealers engage in sales transactions involving ‘Off-Brand’ trade-ins. Currently, if a dealer for Caterpillar (CAT) brand products dealer (i.e., an on-brand dealer) takes a non-CAT machine in on trade, there are several adverse issues that exist in selling such piece of equipment. Examples of such adverse issues include, but are not limited to, on-brand dealers do not have the ability to service off-brand units, off-brand units sold in territory take away from new sales, the buyers of off-brand units are most often the corresponding on-brand dealer, and there is no common trade platform or marketing channel for this transaction to take place other than a manual search and find one call at a time approach. Implementing virtual inventory management in accordance with embodiments of the present invention in The Heavy Equipment Exchange addresses these issues in a number of ways, such as facilitating an instant message to all corresponding on-brand dealers alerting them to the new searchable item availability, eliminating the middleman (auction/broker) whereby buyers and sellers communicate directly, using increased speed plus the aggregation of supply and demand to normalize pricing via proven economic models, and direct dealing between buyers and sellers reducing net bottom line cost.

Implementing virtual inventory management in accordance with embodiments of the present invention in The Heavy Equipment Exchange advantageously impacts the manner in which dealers engage in sales transactions involving surplus inventory. It is well known that every business has aged, surplus or low demand inventory they would like to eliminate and free up capital. These units may be identified by normal inventory metrics. Virtual inventory management in accordance with embodiments of the present invention eliminates time delays, the middlemen and marketing costs thru an automated process, thereby allowing for more effective inventory turnover and lower carrying costs for the sellers and opportunities for the purchaser who has known buyers. Virtual inventory management in accordance with embodiments of the present invention provides for available inventory items therein to be matched with buyer requests, where in a traditional inventory search otherwise available dealer inventory items would be unavailable/unknown to both the buyer and the seller. Furthermore, alerts can be sent to all interested buyers of specified inventory items and sellers can track real demand (e.g., in real-time) for items indicated as available for search.

Implementing virtual inventory management in accordance with embodiments of the present invention in The Heavy Equipment Exchange advantageously impacts the manner in which dealers manage lost sales capture rate. It is known that at least 30% of the sales that are not able to be filled due to lack of available inventory at the time a customer requests will be lost. The customer will “dealer shop” and find the unit elsewhere. Thus, the relationship and downstream parts and service business will be jeopardized if not lost outright. By aggregating searchable supply, virtual inventory management in accordance with embodiments of the present invention allows any OEM or Independent dealer/member to locate the needed unit and engage instantly if it is available with any member, thereby holding onto the customer and servicing his need immediately and in the future. By helping customers understand the merits of virtual inventory, a dealer can eliminate the “dealer shopping” by the customer and do it with them virtually to meet his need. Furthermore, virtual inventory management in accordance with embodiments of the present invention provides the ability to search inventory that may not be actively being listed on a public listing site or otherwise being marketed (e.g., units in rental fleets, units coming off of lease, newly traded in machines, etc.).

Implementing virtual inventory management in accordance with embodiments of the present invention in The Heavy Equipment Exchange advantageously impacts the manner in which dealers are able to reduced cost. By automatically handling the steps between buyer and seller, virtual inventory management in accordance with embodiments of the present invention improves member profitability and increases return on invested capital by enabling more with less due to speed of transactions, increased transaction volume, increase inventory turns, increase rental fleet utilization, and reduced headcount of dealer based wholesale brokers for both domestic and export sales.

Implementing virtual inventory management in accordance with embodiments of the present invention in The Heavy Equipment Exchange advantageously impacts the manner in which dealers optimize rental fleet utilization. A problem for OE dealer rental fleet owners is how to dispose of the growing volume of rental units that are being pumped through their systems due to shorter fleet turnover periods and OEM pushed units. Hence, the reliance on auctions and wholesale brokers who have limited buyers and higher costs plus, price control leaving sellers at their mercy. These channels add 15-20% to the bottom line cost for dealers. (fees to sell and deflated margins). This process produces inconsistent pricing with up to 35% variation in adjacent markets (state to state), which benefit the savvy brokers and auctioneers. In contrast, virtual inventory management in accordance with embodiments of the present invention aggregates wholesale buyers and sellers (e.g., from around the world) in a real time market place. Such buyers and sellers are now able to market their inventory instantly at normalized market prices and other OEM and Independent dealers can be notified instantly of the availability of the item, whereby transactions by sellers will increase available capital increase revenue.

With respect to price normalization, it is well known that there is a price disparity of from 5% to 35+% across the United States. This is caused by a broker and auction controlled market in which auction sales are periodic so that there is not a constant flow of demand and supply. Similarly, the broker sales are opportunistic in that they tend to locate a buyer first before committing to take a used machine from a dealer. Thus, the broker offers the price that creates the greatest benefit for him knowing the dealer wants to move the machine quickly (especially with off-brand). The broker controls the price on both sides of the trade and often adds a fee to the margin it generates for itself (e.g. 5% fee+10-15+% margin). Auctions add cost to both the seller (e.g., typically 6%-12%) and add fees to the buyer maybe (e.g., 10%), whereby the net price to the seller is 80% to 85% of the transaction price. Both the broker and the auction are inefficient markets with third parties creating a distortion in the real market price of the product. In contrast, by implementing virtual inventory management in accordance with an embodiment of the present invention, buyers and sellers are aggregated in a real time market whereby the transaction prices more clearly represent the real market. Thus, the price deviations are much smaller and the demand is more closely matched to supply, creating less deviation from the equilibrium market price.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A system, comprising:
a plurality of dealer inventory management apparatuses each associated with a respective one of a plurality of inventory item dealers, wherein each one of the inventory item dealers is a dealer for a respective brand of inventory item; and
a virtual inventory management server accessible by each one of the dealer inventory management apparatuses, wherein the virtual inventory management server enables a cross-brand virtual inventory of each one of the inventory item dealers to be created and searched and wherein the cross-brand virtual inventory of a particular one of the inventory item dealers includes inventory of at least one other one of the inventory item dealers.

2. The system of claim 1 wherein at least one of the inventory item dealers is a dealer for a respective brand of inventory item different than each other one of the plurality of inventory item dealers.

3. The system of claim 1 wherein the cross-brand virtual inventory of a first one of the inventory item dealers includes inventory different that the cross-brand virtual inventory of a second one of the inventory item dealers.

4. The system of claim 1 wherein:
each one of the dealer inventory management apparatuses maintains inventory item information for each item of the inventory of the respective one of the inventory item dealers within inventory information fields of a respective dealer inventory record thereof;
the virtual inventory management server includes a data structure having virtual inventory information fields;
the virtual inventory management server enables at least a portion of the inventory information fields of each one of the dealer inventory management apparatuses to be selectively mapped to a corresponding one of the virtual inventory information fields; and
the cross-brand virtual inventory of each one of the inventory item dealers is created using the inventory item information maintained within at least a portion of the virtual inventory information fields.

5. The system of claim 4 wherein at least one of the inventory item dealers is a dealer for a respective brand of inventory item different than each other one of the plurality of inventory item dealers.

6. The system of claim 4 wherein the cross-brand virtual inventory of a first one of the inventory item dealers includes inventory different that the cross-brand virtual inventory of a second one of the inventory item dealers.

7. The system of claim 4 wherein:
the inventory information fields of each one of the dealer inventory management apparatuses includes a plurality of inventory item parameter names; and
at least a portion of the inventory item parameter names of a first one of the dealer inventory management apparatuses is different than at least a portion of the inventory item parameter names of a first one of the dealer inventory management apparatuses.

8. The system of claim 7 wherein:
at least one of the inventory item dealers is a dealer for a respective brand of inventory item different than each other one of the plurality of inventory item dealers; and
the cross-brand virtual inventory of a first one of the inventory item dealers includes inventory different that the cross-brand virtual inventory of a second one of the inventory item dealers.

9. A method implemented via execution of instructions by one or more data processing devices in response to being accessed from memory by the one or more data processing devices, the method comprising:
receiving, from each one of a plurality of inventory item dealers, inventory item information for at least one inventory item thereof;
maintaining information enabling a virtual inventory for each one of the inventory item dealers to be determined; and
in response to receiving a search request from a particular one of the inventory item dealers, searching the virtual inventory of the particular one of the inventory item dealers for an inventory item specified in the search request, wherein the virtual inventory of the particular one of the inventory item dealers includes the at least one inventory item of at least one other one of the inventory item dealers.

10. The method of claim 9, further comprising:
using the information enabling the virtual inventory for each one of the inventory item dealers to be determined to define a subset of inventory item dealers from the plurality of inventory item dealers, wherein searching the virtual inventory of the particular one of the inventory item dealers includes searching the inventory of the subset of inventory item dealers.

11. The method of claim 9, further comprising:
transmitting inventory items identified from said searching for reception by the particular one of the inventory item dealers; and
designating each one of said inventory items identified from said searching that is an off-brand inventory item of the respective one of the inventory item dealers.

12. The method of claim 9, further comprising:
receiving, from each one of the plurality of inventory item dealers, information characterizing a brand for which a respective one of the inventory item dealers is an authorized dealer thereby enabling off-brand inventory items thereof to be determined.

13. The method of claim 12, further comprising:
transmitting inventory items identified from said searching for reception by the particular one of the inventory item dealers; and
designating each one of said inventory items identified from said searching that is an off-brand inventory item of the respective one of the inventory item dealers.

14. The method of claim 9, further comprising:
receiving, from each one of the inventory item dealers, information defining a plurality of inventory item parameter names for inventory thereof; and
enabling at least a portion of the inventory item parameter names of a particular one of the inventory item dealers to be selectively mapped to a corresponding one of a plurality of virtual inventory information fields by the particular one of the inventory item dealers.

15. The method of claim 14, further comprising:
receiving, from each one of the plurality of inventory item dealers, information characterizing a brand for which a respective one of the inventory item dealers is an authorized dealer thereby enabling off-brand inventory items thereof to be determined;
transmitting inventory items identified from said searching for reception by the particular one of the inventory item dealers; and
designating each one of said inventory items identified from said searching that is an off-brand inventory item of the respective one of the inventory item dealers.

16. The method of claim 9, further comprising:
receiving a sales order fulfillment request from the particular one of the inventory item dealers for an inventory item identified in response to searching the virtual inventory of the particular one of the inventory item dealers;
after receiving the sales order fulfillment request, receiving confirmation that a required amount of monetary funds have been deposited into a specified escrow account; and
issuing authorization for distribution of at least a portion of the monetary funds from the specified escrow account in response to confirmation of mutual compliance of inspection requirements for said identified inventory item by the particular one of the inventory item dealers and a respective one of the inventory item dealers from which the inventory item information thereof has been received.

17. A server, comprising:
a data structure including inventory item information for at least one inventory item of each one of a plurality of inventory item dealers and virtual inventory specifying information for each one of the inventory item dealers, wherein the virtual inventory specifying information for each one of the inventory item dealers defines one or more other inventory item dealers whose inventory is included in a virtual inventory thereof; and
a virtual inventory management engine coupled to the data structure and configured for searching the virtual inventory of a particular one of the inventory item dealers for an inventory item specified in a search request received therefrom.

18. The server of claim 17 wherein:
the virtual inventory specifying information for each one of the inventory item dealers includes receiving information characterizing a brand for which a respective one of the inventory item dealers is an authorized dealer; and
the virtual inventory management engine uses said brand characterizing information for determining off-brand inventory items identified in said searching of the virtual inventory of the particular one of the inventory item dealers.

19. The server of claim 17 wherein:
the inventory item information of each one of the inventory item dealers includes a plurality of inventory item parameter names for inventory thereof; and
the virtual inventory management engine is configured for enabling at least a portion of the inventory item parameter names of a particular one of the inventory item dealers to be selectively mapped to a corresponding one of a plurality of virtual inventory information fields by the particular one of the inventory item dealers.

20. The server of claim 17, further comprising:
a virtual inventory sales order management engine configured for implementing escrow-protected sales order fulfillment for any of inventory item identified in said searching of the virtual inventory of the particular one of the inventory item dealers.
